(19) United States
(12) Patent Application Publication
(10) Pub. No.: US 2015/0046250 A1
(43) Pub. Date: Feb. 12, 2015

(54) System and Method for Determining the Effectiveness of Marketing Content

(71) Applicant: Ijento Limited, Abingdon (GB)

(72) Inventors: Robert Keith WILLIAMS, Abingdon (GB); Philip Neil MASON, Sutton Witney (GB); Peter John David RYAN, Ipswich (GB)

(21) Appl. No.: 14/452,998

(22) Filed: Aug. 6, 2014

(30) Foreign Application Priority Data
Aug. 7, 2013 (GB) 1314118.9

(51) Int. Cl. G06Q 30/02

(52) U.S. Cl. CPC G06Q 30/0242
USPC 705/14.41

(57) ABSTRACT

A method of determining the effectiveness of marketing content comprising the steps of recording user access to items of marketing content. Recording customer transactions, and for each transaction, identifying previous access to items of marketing content by the same customer. Assigning a value to each of the identified accessed items of marketing content, the assigned value being derived from the value of the transaction. Then combining the values assigned to each accessed item of marketing content by the different transactions to provide a customer score for that item, and deriving a performance score for each item of marketing content from the customer score for that item and the recorded user access for that item.

### CROSS-REFERENCE TO RELATED APPLICATIONS

The present application claims priority under 35 U.S.C. §119 of British Patent Application GB1314118.9, filed Aug. 7, 2013, the entire disclosure of which is expressly incorporated by reference herein.

### FIELD OF THE INVENTION

This invention relates to a system and method for determining the effectiveness of marketing content, and in particular to a system and method for determining the effectiveness of website pages.

### DESCRIPTION OF THE RELATED ART

Many companies use marketing content, such as pages on a company website, to publicize and advertise their products and services. However, it is difficult to determine the effectiveness of the different items of marketing content, for example the individual pages of a website. As a result, it is difficult to compare the relative value of different items of marketing content.

One approach is for the effectiveness of different marketing content is for an expert or experts to review the content and estimate its effectiveness. However, because this approach is based on a subjective opinion of how the content will affect the public, it is unreliable and highly vulnerable to results being biased by individual tastes and assumptions.

Another approach is for multiple members of the public to be interviewed and surveyed about the content. The responses can then be analyzed to estimate the content's effectiveness. The use of multiple interviewees is intended to reduce any bias by individual tastes. However, because this approach is based on a subjective opinion of how the content will affect the public, it is unreliable. Furthermore, this approach may be undesirably expensive.

### SUMMARY OF THE INVENTION

In one aspect the present invention provides a method of determining the effectiveness of marketing content comprising the steps of:

recording user access to items of marketing content;

recording customer transactions;

for each transaction, identifying previous access to items of marketing content by the same customer;

assigning a value to each of the identified accessed items of marketing content, the assigned value being derived from the value of the transaction;

combining the values assigned to each accessed item of marketing content by the different transactions to provide a customer score for that item;

deriving a performance score for each item of marketing content from the customer score for that item and the recorded user access for that item.

Preferably, the method comprises a further step of selecting a time period, and only customer transactions within the time period are considered.

Preferably, only customer access to items of marketing content within the time period are considered.

Preferably, the value of the transaction is the total transaction value.

Preferably, the value of the transaction is the profit value of the transaction.

Preferably, the value assigned to each of the identified accessed items of marketing content is a share of the value of the transaction divided between the items of marketing content identified for that transaction.

Preferably, the value of the transaction is divided equally between the items of marketing content identified for that transaction.

Preferably, when items of marketing content have been accessed multiple times, the division is made by counting each identified access to an item of marketing content separately.

Preferably, the values assigned to each accessed item of marketing content by different transactions are summed to provide a customer score for that item.

Preferably, the performance score for each item of marketing content is derived by dividing the customer score for that item by the recorded user access for that item.

Preferably, the recorded user access for an item is the number of times the item has been accessed.

Preferably, the recorded user access for an item is the number of times the item has been accessed by a different user.

Preferably, the performance score for each item of marketing content is derived by multiplying the customer score for that item by the total recorded user access for all items.

Preferably, the performance score for each item of marketing content is a single value.

Preferably, the performance scores are output as an ordered list.

Preferably, the performance score for each item of marketing content is a vector comprising two or more values.

Preferably, the performance score is a vector comprising two values.

Preferably, the items of marketing content are pages on a website.

The invention further provides systems, devices and articles of manufacture for implementing any of the aforementioned aspects of the invention.

### DESCRIPTION OF FIGURES

The invention will now be described in detail with reference to the following figures in which:

FIG. 1 is a diagram of an example of a system for determining the effectiveness of on line marketing content according to the invention;

FIG. 2 is a flowchart showing an example of a method of operation of the system of FIG. 1; and

FIG. 3 is an explanatory diagram.

### DETAILED DESCRIPTION OF THE INVENTION

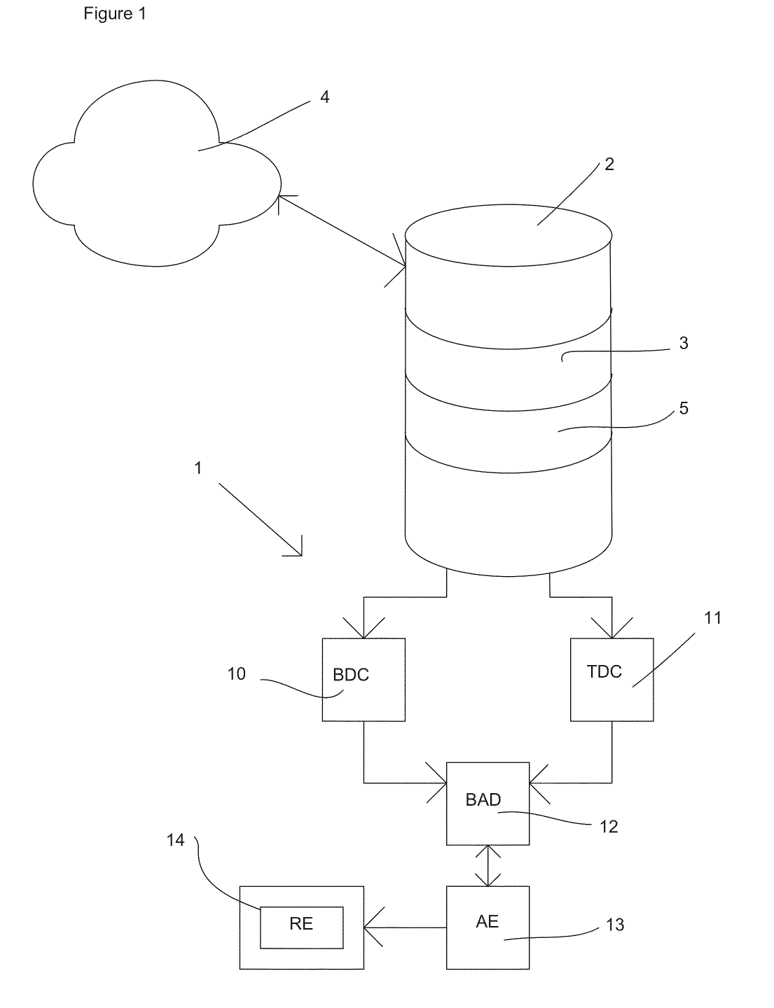

An example of a system 1 for determining the effectiveness of online marketing content is illustrated in FIG. 1.

In the example of FIG. 1 a server 2 hosts a vendor website 3. In this example the vendor provides products for purchase by customers accessing the website 3 through a public communication network 4, such as the internet. The website 3 comprises a plurality of web pages interconnected by links so that a potential customer can navigate around the website 3 in order to view, and otherwise interact with, the different ones of the plurality of web pages. The web pages each comprise marketing content. The web pages may, for example, include product guide pages, pages describing and/or illustrating groups of products or individual products, and checkout pages allowing selected products to be purchased online. The server 2 also supports a transaction engine 5 which can execute financial transactions in order to allow customers to purchase products based on information input into the checkout pages by customers.

The system 1 comprises a behavior data collector 10, a transaction data collector 11, a behavior analytical database 12, an analytical engine 13, and a reporting system 14.

The behavior data. collector 10 collects data about customer behavior from the website 3. The behavior data collector 10 collects information identifying which marketing content is accessed by each customer, and at which time. in the example of FIG. 1 the marketing content accessed by a customer is the web pages accessed by the customer. In some examples the behavior data collector 10 may be a tag-based web analytics system.

The transaction data collector 11 collects transaction data about customer transactions from the transaction engine 5. The transaction data collector 11 collects information about the financial transactions carried out by each customer including the value and time of each transaction. In the example of FIG. 1 the transactions are purchases of products from the website. In some examples the transaction data collector 11 may be an online order processing system.

In one example the behavior data collector 10 and the transaction data collector 11 collect data on an ongoing basis, or in other words, in real time as customers access marketing content and carry out transactions. In other examples either or both of the behavior data collector 10 and the transaction data collector 11 may collect data retrospectively and intermittently, for example daily.

In examples where the behavior data collector 10 is a tag-based web analytics system the web analytics tags collect and record the data on an ongoing basis.

The behavior data collector 10 and the transaction data collector 11 each provide their collected data to the behavior analytical database 12. The behavior analytical database 12 combines and stores the customer behavior data from the behavior data collector 10 and the transaction data from the transaction data collector 11 to form combined records of marketing content accessed and transactions carried out by each customer. In some examples the behavior analytical database 12 may be a digital analytics datamart.

In one example the behavior data collector 10 and the transaction data collector 11 may provide data on an ongoing basis, or in other words, in real time, to the behavior analytical database 12. In other examples either or both of the behavior data collector 10 and the transaction data collector 11 may provide data retrospectively and intermittently, for example daily.

In examples where one or both of the behavior data collector 10 and the transaction data collector 11 provides data retrospectively and intermittently, the behavior data collector 10 and/or transaction data collector 11 providing data retrospectively and intermittently may either collect data on an ongoing basis or retrospectively and intermittently. It is not essential that data which is provided retrospectively and intermittently is also collected retrospectively and intermittently.

The analytical engine 13 is able to access the combined records stored in the behavior analytical database 12 and process the records to assign a value to each item of marketing content accessed by a customer based on transactions carried out by that customer. How this value is determined will be explained in detail below. The analytical engine 13 may be a software module executed on a computer operating in conjunction with the behavior data collector 10.

The reporting system 14 presents the values assigned to the different items of marketing content to a user, These values may then be used to quantify the value or effectiveness of the different items of marketing content so that informed decisions can be made regarding changes to the marketing content.

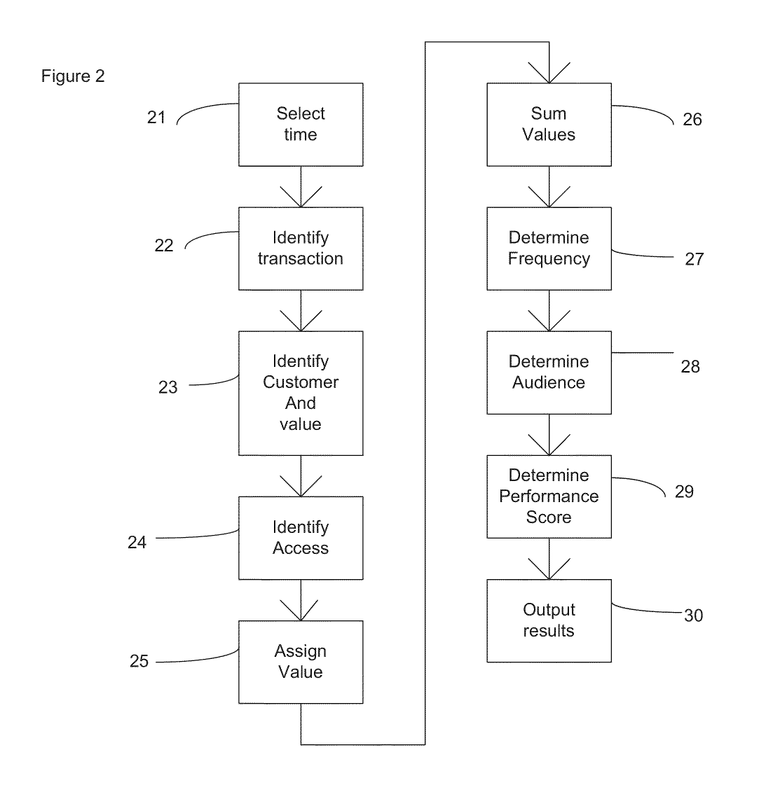

An example of the processing of the combined records by the analytical engine 13 will now be described with reference to FIG. 2. FIG. 2 is a flow chart of an example of a processing method executed by the analytical engine 13.

In a first step 21 a time period is selected to be the basis for the analysis. The length of the time period selected may vary on a case by case basis based on user requirements. In general it is expected that, for statistical reasons, the accuracy and reliability of the analysis results will be improved by analyzing data over a longer time period. However, it is also expected that the value of the results of the analysis will be increased if the marketing content is stable, or at least substantially stable, over the time period forming the basis of the analysis.

The length of the time period selected to be the basis for the analysis may depend upon the nature of the vendor business operating through the website. For example, a business with a long sales cycle may require analysis over a long time period in order for the analysis to provide useful data. In another example, a business with a short sales cycle may be able to obtain useful data form analysis over a short time period, but may also obtain further useful data from analysis over a longer time period.

The time period selection will generally be made by a human user of the system 1 through a suitable user interface (not shown in the figures). In some examples the system may prompt the user by suggesting suitable possible time periods for selection, or the time period selection may be made automatically. In such examples the suggested or selected time periods may be automatically set to extend between successive significant changes in the marketing content.

The selected time period may be different on different occasions. For example, the system may carry out an analysis at the end of each day over a selected time period of one day, and also carry out an analysis at the end of each month over a selected time period of one month.

Next, in step 22, the analytical engine 13 searches the records stored in the behavior analytical database 12 and identifies all of the transactions which took place within the selected time period. Then, in step 23, the analytical engine 13 uses the records stored in the behavior analytical database 12 to identify the customer who made each of the identified transactions and to identify the value associated with each of the identified transactions. For a transaction Ti, the associated value may be Vᵢ.

In one example, where a transaction is a product purchase, the value associated with a transaction is the gross amount paid by the customer for the purchase. In other examples the value associated with a transaction may be the profit made by the vendor from the purchase, or in other words the profit margin. Other measures of value may be used if desired. In practice, different measures of value may be found to be more useful in different implementations, the most appropriate or useful measure of value may depend, for example, on the nature of the products, the type of vendor, and/or the nature of the transactions.

In some examples the value associated with a transaction may be changed during the processing. In one example, the transaction may be recorded as a gross cash value by the transaction engine 5, because this is the usual transaction value format recorded by the transaction engine 5. When this data is collected by the transaction data collector 11 it is converted or transformed into a margin value corresponding to the profit made on the transaction before being recorded in the behavior analytical database 12. In other examples this conversion or translation may be carried out by other parts of the system, for example the behavior analytical database 12 or the analytical engine 13.

Next, in step 24, for each of the transactions identified in step 22, the analytical engine 13 searches the records stored in the behavior analytical database 12, identifies all of the previous instances of the accessing of items of marketing content by the customer who made the transaction, that is, instances of the accessing of marketing content which occurred at an earlier time than the transaction, and associates these instances of accessing the marketing content with the transaction. In principle the records could be searched to identify instances of the accessing of marketing content going back to when the collection of data was started, or for any desired shorter length of time. In some examples a time limit may be set limiting how far back in time instances of the accessing of marketing content are searched, this may help to prevent undue processing demands being placed on the analytical engine 13. In some examples this time limit may be a month. In some examples the time limit may be a previous occasion on which the marketing content was significantly changed, because historical information regarding earlier versions of the marketing content may not be of interest.

In some examples there may be a limit on the length of time for which records are stored in the behavior analytical database 12, which will by default place a limit on how far back in time instances of the accessing of marketing content can be searched.

There is no general requirement that the searched and identified instances of the accessing of marketing content are limited to the selected time period. However, in some instances this may be the case. This may occur in examples where there has been a significant change in the marketing materials, and the time of the change is both the start of the selected time period and the time limit for searching for instances of the accessing of marketing content. This may also occur by default when the website has only recently been established so that the stored records only go back a relatively short time.

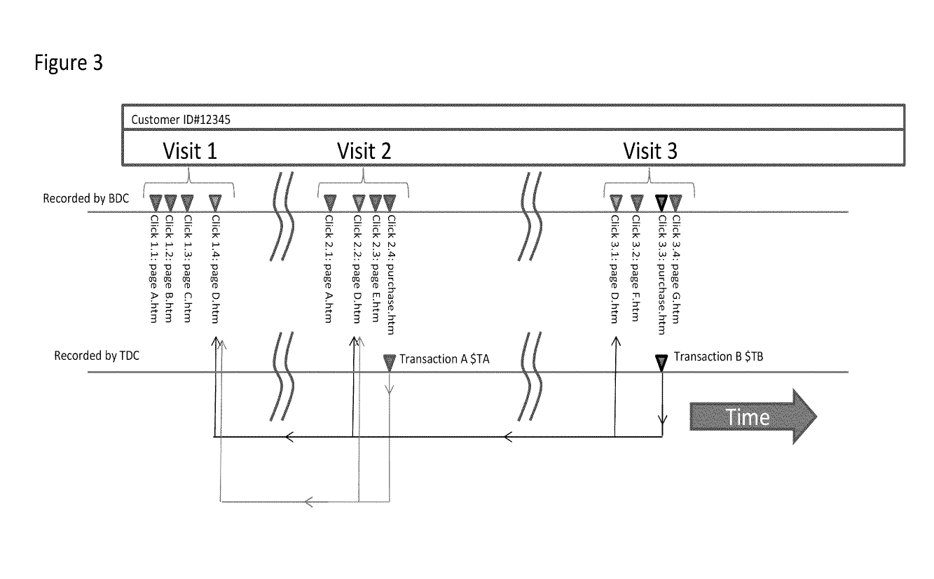

FIG. 3 shows an explanatory diagram to assist in understanding the steps of the method discussed above. FIG. 3 shows a representation of the activity of a customer, who has been assigned the identity number 12345, during the selected time period.

In a first visit 1 to the vendor website the customer views website pages A, B, C, and D, but makes no purchase. Subsequently, the customer makes a second visit to the website and views pages A, D and E, and then makes a purchase A. Finally, the customer makes a third visit to the website and views pages D and F, then makes a purchase B and finally views page G.

The pages A to E are associated with the purchase A, while the pages A to F are associated with the purchase B. The page G is not associated with either purchase.

Next, in step 25, the analytical engine 13 assigns a portion of the value associated with each transaction to each item of marketing content that was associated with that transaction in step 24. If an item of marketing content was associated with a transaction multiple times, that item of marketing content is assigned a portion of the value for each time it was associated. In one example the value is divided equally between the associations of items of marketing content the transaction so that an equal portion of the value is assigned for each association.

In the example of FIG. 3 the value of purchase A is divided between the pages A to E. However, since pages A and D were viewed twice these pages are assigned twice as much value as pages B and C. Thus, two sevenths of the value of purchase A is assigned to each of pages A and D and one seventh of the value is assigned to each of pages B, C and E.

Similarly, three ninths of the value of purchase B is assigned to page D, two ninths is assigned to page A, and one ninth of the value is assigned to each of pages B, C, E and F.

The page G is not assigned any value.

Steps 24 and 25 are carried out by the analytical engine 13 for each of the transactions identified in step 22 until the value associated with every identified transaction has been assigned to, and if necessary divided between, the associated items of marketing content.

Next, in step 26, for each item of marketing content which has been assigned any value in step 25, all of the values associated with that item of marketing content from all of the different transactions associated with it are summed by the analytical engine 13 to generate a total score assigned to that item of marketing content. For an item of marketing content Cj, the assigned score may be Sⱼ.

In some examples the assigned score associated with each item of marketing content may be generated as a cumulative total of the portions of value associated with the item of marketing content from different transactions during step 25. In such examples a separate step 26 may not be required.

Next, in step 27, the analytical engine 13 searches the records stored in the behavior analytical database 12, and for each of the items of marketing content which have been assigned a score determines the total number of times that that item of marketing content has been accessed by any customer during the selected time period. This number of times accessed is assigned to the item of marketing content as a frequency value. For an item of marketing content Cj, the assigned frequency value may be Fⱼ.

Next in step 28, the analytical engine 13 searches the records stored in the behavior analytical database 12, and for each of the items of marketing content which have been assigned a score determines the total audience for that item of marketing content. In one example the total audience for an item of marketing content is the number of times the item of marketing content has been accessed by any customer. Where the item of marketing content is a web page this may be the number of times the web page has been viewed. For an item of marketing content Cj, the assigned audience value may be Aⱼ.

It should be understood that the audience value for an item of marketing content may be, and usually will be, different from the frequency value, because customers who have not made any transaction may have accessed the item of marketing content, and such non-transaction customer access will be included in the audience value, but not in the frequency value.

In other examples different methods of determining the assigned audience value may be used. In some examples the audience value may be the number of visits in which the page appears at least once. In some examples the audience value may be the number of unique visitors who view the page at least once.

Then, in step 29, for each of the items of marketing content identified in step 24, the analytical engine 13 combines the values assigned to the item of marketing content using a mathematical function to obtain a performance score for that item of marketing content.

In one example, for an item of marketing content Cⱼ the performance score Pⱼ may be defined as:

Pⱼ=Aⱼ*Sⱼ/Fⱼ (equation 1)

In other examples different mathematical functions may be used instead of equation 1. In some examples a performance score may be defined as a vector of two or more values instead of a single score value.

Then, in step 30, the performance scores for the different items of marketing content are output to a user through the reporting system 14. The performance scores are also stored for future review and/or analysis. In one example the performance scores from the analytical engine 13 are passed directly to the reporting system 14. In other examples the performance scores from the analytical engine 13 are returned to the behavior analytical database 12, or another storage device, and stored for later access by the reporting system 14.

Items of marketing content having the highest score are considered as being the most effective. The performance score for each item of marketing content provides a metric of its effectiveness.

Conveniently the performance scores for the different items of marketing content can be output as an ordered list by the reporting system 14.

In examples where the performance score is defined as a vector of two or more values, the performance scores for the different items of marketing content can be output as a graph. If the two values or each vector score for each item of marketing content is plotted on a 2 dimensional graph the graph can be used to identify the better and worse performing items.

By comparing the performance scores of the different s of marketing content the effectiveness of the different items of marketing content can be identified and assessed. The action taken in response to this assessment will depend on the circumstances in any particular case. However, it will be clear to the person skilled in the field of online marketing or transactions how an assessment of the relative effectiveness of the items of marketing content in use can be used to direct changes to the marketing content. For example, if resources are available to edit the items of marketing content it may be more efficient to direct these resources to the items of marketing content which are less effective. In another example, if items of marketing content are changed and the new content is less effective than the previous content the changes may be reversed.

The performance scores indicate the relative effectiveness of different items of marketing content of a vendor. In some examples it may possible to compare the performance scores of marketing content of different vendors. However, in other examples it may be difficult to meaningfully compare the performance scores of marketing content of different vendors or websites because of the influence on the performance scores of differences in the marketing or transaction policies of the different vendors or websites.

In many cases there will be items of marketing content which are accessed by potential customers during the selected time period but are not linked to any transaction. Such items of marketing content are not assigned any value in step 25 or score in step 26, in one example such items are assigned a performance score of zero. In other examples such items may be excluded from the generated performance scores.

In some examples, items of marketing content which are accessed but are not linked to any transaction are assigned a frequency value in step 27, and these frequency values are used to generate performance scores for the items.

In one implementation the performance scores generated by the analytical engine 13 are reported to a human operator by the reporting system 14. The human operator can then analyze the performance scores to identify particular components of the marketing content which are performing poorly and require attention from a human designer. The example discussed above of providing the performance scores in an ordered list is convenient for use in such a manual process.

In another implementation the performance scores generated by the analytical engine 13 are provided to an automatic system or process for editing the marketing content. For example, the performance scores may indicate poorly performing marketing content components which should be given a higher priority in an automated multivariate testing system. Such an automated system may automatically generate marketing content from templates and vary the generation process or change the template if the marketing content is performing poorly.

Although the manual and automatic implementations are described as alternatives above, they may be combined in a single implementation.

The performance scores may be used to directly identify poorly performing items of marketing content. The performance scores may also be used to carry out more sophisticated analyses. For example, groups of linked items of marketing content having low performance scores may indicate problems with the structure of a website, or groups of items of marketing content having a common format having low performance scores may indicate problems with the format.

In the example described above items of marketing content having the highest performance score are considered as being the most effective. This depends upon the mathematical function used to generate the performance score. In some examples the mathematical function may be such that the items having the lowest score are the most effective.

In some examples the value associated with each transaction, which is divided between the associated items of marketing content in step 25, may be altered retrospectively in response to events after the transaction has been completed. For example, if a customer makes a purchase and subsequently returns the item for a refund, the value associated with the original purchase transaction may be reduced to zero. In some examples the value may be reduced to a negative amount, based on the administrative cost to the vendor of carrying out the purchase and refund.

In practice, it is common for customers to access websites or other marketing material using a number of different devices, for example a customer may access a website using a laptop and a smartphone at different times. In order to correctly take access and transactions by the same customer using different devices accurately into account it is desirable to link the customer access and transactions using different devices together. In one example this linking of activity by the same customer on different devices may be carried out by the behavior analytical database 12. In other examples this may be carried out elsewhere, for example by the behavior data collector 10.

In alternative examples different methods of assigning value to items of marketing content in step 25 may be used.

In some examples the time period which has elapsed between the accessing of an item of marketing content by a customer and the subsequent transaction may be taken into account. For example, the longer the intervening time the lower the proportion of the value which is assigned to the accessed item of marketing content.

In some examples the context of the access by the customer may be taken into account. For example, if a customer accesses an item of marketing content such as a website page by way of a search engine query that item may be assigned a greater proportion of the value of a subsequent transaction as it may be judged likely to have a greater influence on the customer.

In general the number of items of marketing content accessed by a customer should be taken into account, with the transaction value being shared between the accessed items. However this sharing or weighting may take different forms in different examples.

As noted above, in other examples different mathematical functions may be used instead of equation 1. There are many possible functions which can be used, and different functions may be appropriate in different applications. In most examples it is expected that the mathematical function should produce a performance score which indicates the relative importance of the item of marketing content in influencing the overall customer audience to carry out transactions, not just the influence on the customers Who make transactions. Where the item of marketing content is a page on a website factors which may be taken into account include, but are not limited to, the number of times the page is shown, the number of customer visits to the website in which the page appears at least once, and the number of unique visitors to the website who view the page at least once.

It will be understood from the above description that the system needs to be able to identify customers carrying out transactions and accessing the marketing content. The customers only need to be identified sufficiently that transactions and access by the same customer can be linked. It is not necessary that the customers actual identities, for example the names of the customers, are recorded. In one example the system may assign customers alphanumeric identifiers in order to anonymize the customers and avoid any issues regarding the retention and security of customer personal information.

In one example customers are identified using tracking cookies. It is a normal practice for vendor websites offering products for purchase to use tracking cookies, so this will generally be straightforward. In other examples customers may log in to the website, or other identifying means, such as tracking IP addresses may be used.

The above description relates to an implementation in which customers access the marketing content and carry out transactions on-line through a website. In other implementations customers may access marketing content and carry out transactions via multiple channels. For example, customers may use email and/or telephone calls to a call centre in addition to on-line channels. in such implementations some means is required to identify the customer as the same customer across the different channels. For example, the customer may log on through the different channels using the same identifier.

The above description refers to transactions. In some examples the transactions may be purchases of products. The products may be goods or services. In other examples transactions may be other forms than purchases, for example auction bids or insurance quotes.

In some alternative examples information may be passed between the different components of the system through intermediate components or systems.

The apparatus described above may be implemented at least in part in software. Those skilled in the art will appreciate that the apparatus described above may be implemented using general purpose computer equipment or using bespoke equipment.

The different components of the system may be provided by software modules executing on a computer.

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. A method of determining the effectiveness of marketing content comprising the steps of:
recording user access to items of marketing content;
recording customer transactions;
for each transaction, identifying previous access to items of marketing content by the same customer;
assigning a value to each of the identified accessed items of marketing content, the assigned value being derived from the value of the transaction;
combining the values assigned to each accessed item of marketing content by the different transactions to provide a customer score for that item;
deriving a performance score for each item of marketing content from the customer score for that item and the recorded user access for that item.

2. The method of claim 1, wherein the method comprises a further step of selecting a time period, and only customer transactions within the time period are considered.

3. The method of claim 2, wherein only customer access to items of marketing content within the time period are considered.

4. The method of claim 1, wherein the value of the transaction is the total transaction value.

5. The method of claim 1, wherein the value of the transaction is the profit value of the transaction.

6. The method of claim 1, wherein the value assigned to each of the identified accessed items of marketing content is a share of the value of the transaction divided between the items of marketing content identified for that transaction.

7. The method of claim 1, wherein the value of the transaction is divided equally between the items of marketing content identified for that transaction.

8. The method of claim 6, wherein, when items of marketing content have been accessed multiple times, the division is made by counting each identified access to an item of marketing content separately.

9. The method of claim 1, wherein the values assigned to each accessed item of marketing content by different transactions are summed to provide a customer score for that item.

10. The method of claim 1, wherein the performance score for each item of marketing content is derived by dividing the customer score for that item by the recorded user access for that item.

11. The method of claim 10, wherein the recorded user access for an item is the number of times the item has been accessed.

12. The method of claim 10, wherein the recorded user access for an item is the number of times the item has been accessed by a different user.

13. The method of claim 1, wherein the performance score for each item of marketing content is derived by multiplying the customer score for that item by the total recorded user access for all items.

14. The method of claim 1, wherein the performance score for each item of marketing content is a single value.

15. The method of claim 1, wherein the performance scores are output as an ordered list.

16. The method of claim 1, wherein the performance score for each item of marketing content is a vector comprising two or more values.

17. The method of claim 16, wherein the performance score is a vector comprising two values.

18. The method of claim 1, wherein the items of marketing content are pages on a website.

19. A system for determining the effectiveness of marketing content comprising:
a behavior data collector for recording user access to items of marketing content;
a transaction data collector for recording customer transactions; and
an analytical engine configured to:
for each transaction, identify previous access to items of marketing content by the same customer;
assign a value to each of the identified accessed items of marketing content, the assigned value being derived from the value of the transaction;
combine the values assigned to each accessed item of marketing content by the different transactions to provide a customer score for that item; and
derive a performance score for each item of marketing content from the customer score for that item and the recorded user access for that item.

20. A computer readable medium storing machine readable instructions which, when executed by a processor of a computer system, causes said system to implement the steps of:
recording user access to items of marketing content;
recording customer transactions;
for each transaction, identifying previous access to items of marketing content by the same customer;
assigning a value to each of the identified accessed items of marketing content, the assigned value being derived from the value of the transaction;
combining the values assigned to each accessed item of marketing content by the different transactions to provide a customer score for that item;
deriving a performance score for each item of marketing content from the customer score for that item and the recorded user access for that item.
